(19) United States
(12) Patent Application Publication
(10) Pub. No.: US 2019/0342040 A1
(43) Pub. Date: Nov. 7, 2019

(54) SCALABLE FEEDBACK REPORTING

(71) Applicant: NOKIA TECHNOLOGIES OY, Espoo (FI)

(72) Inventors: Esa TIIROLA, Kempele (FI); Kari HOOLI, Oulu (FI)

(21) Appl. No.: 16/475,451

(22) PCT Filed: Jan. 3, 2018
(86) PCT No.: PCT/FI2018/050006

§ 371 Date: Jul. 2, 2019

(51) Int. Cl. H04L 1/18; H04L 5/00; H04L 5/14; H04W 72/04; H04W 72/12

(52) U.S. Cl. CPC H04L 1/1864; H04L 1/1854; H04W 72/1242; H04L 5/14; H04W 72/0446; H04L 5/0055

(57) ABSTRACT

Various communication systems may benefit from the appropriate communication of acknowledgements. For example, various communication systems, such as New Radio, may benefit from a scalable codebook size definition in a scenario with dynamically varying acknowledgement timing. A method can include receiving a timing offset value in a downlink grant (910). The method can also include determining a first downlink time slot within a feedback window based on the timing offset value (920).

### BACKGROUND

### Field

Various communication systems may benefit from the appropriate communication of acknowledgments. For example, various communication systems, such as New Radio, may benefit from a scalable feedback reporting in a scenario with dynamically varying acknowledgment timing.

### Description of the Related Art

Third generation partnership project (3GPP) New Radio (NR) physical layer design has a related 3GPP study item (RP-160671) for which an objective to identify and develop technology components needed for NR systems being able to use any spectrum band ranging at least up to 100 GHz. The goal is to achieve a single technical framework addressing all usage scenarios, requirements and deployment scenarios defined in 3GPP TR 38.913.

### BRIEF DESCRIPTION OF THE DRAWINGS

For proper understanding of the present disclosure, reference should be made to the accompanying drawings, wherein:

FIG. 1 illustrates slot types in new radio.

FIG. 2 illustrates an example scenario for determining a HARQ-ACK feedback (FB) window for one virtual HARQ-ACK cell, according to certain embodiments.

FIG. 3 illustrates a mapping of timing indicator values to A/N offset slots, according to certain embodiments.

FIG. 4 illustrates a scenario with two virtual HARQ-ACK cells, according to certain embodiments.

FIG. 5 illustrates an example implementation in time domain, according to certain embodiments.

FIG. 6 illustrates another example implementation, according to certain embodiments.

FIG. 7 illustrates an exemplary scenario, according to certain embodiments.

FIG. 8 illustrates an example of error case handling, according to certain embodiments.

FIG. 9 illustrates a method according to certain embodiments.

FIG. 10 illustrates a system according to certain embodiments.

### DETAILED DESCRIPTION

NR may need to support hybrid automatic repeat request (HARQ) acknowledgment (ACK) timing indicated dynamically via layer one (L1) signaling, such as downlink control information (DCI).

Timing relationship between DL data reception and corresponding acknowledgement can be dynamically indicated by L1 signaling (e.g., DCI), semi-statically indicated to a user equipment (UE) via higher layer, or a combination of indication by higher layers and dynamic L1 signaling (e.g., DCI). There may be a minimum interval between DL data reception and corresponding acknowledgement. There may also be common channels, for example for random access.

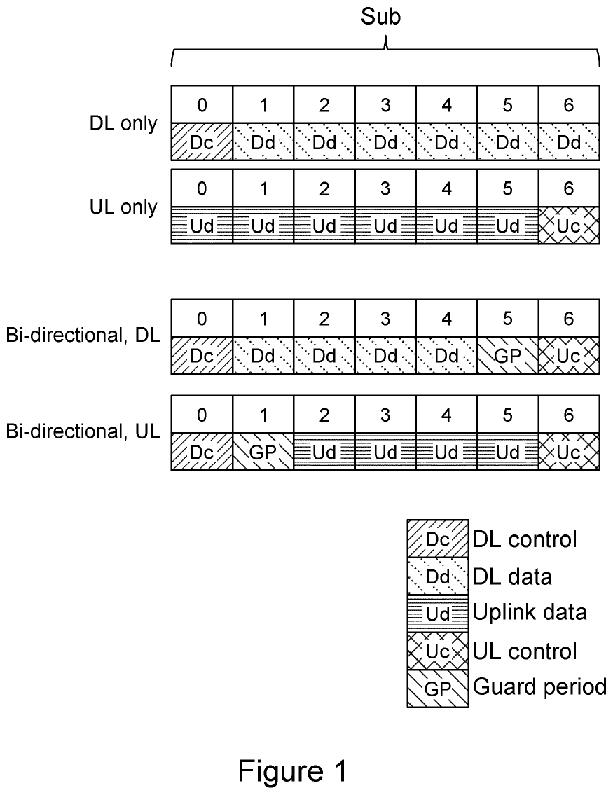

FIG. 1 illustrates slot types in new radio. As shown in FIG. 1, there are three slot types that can provide the basic support for both time division duplex (TDD) and frequency division duplex (FDD). For the bi-directional slots, there is either downlink data or uplink data transmission in each slot, as well as the corresponding downlink and uplink control. Bi-directional slot facilitates many TDD functionalities in the NR frame structure, such as link direction switching between downlink (DL) and uplink (UL), fully flexible traffic adaptation between DL and UL, and opportunity for low latency, provided that slot length is selected to be short enough.

In all slots, multiplexing between DL control, DL/UL data, guard period (GP) and UL control is based primarily on time division multiplexing allowing fast energy efficient pipeline processing of control and data in the receiver. Physical uplink control channel (PUCCH) can be conveyed in the UL control symbol(s) located at the end of the slot. It is also possible to frequency division multiplex UL data and UL control and to convey PUCCH in a long format covering the entire UL portion of the slot.

In addition to bi-directional slots, there are also DL slots and UL slots in FIG. 1. These may be needed at least in FDD mode, but also in certain TDD scenarios to allow longer transmission periods in the same direction. In order to support smooth coverage extension for an UE, it may be possible to extend the transmission of data and control channels over multiple slots.

L1 control signaling can be configured to be flexible enough to support operation without predetermined TDD UL-DL configurations. This is due to the fact that different slot types can be used on a link rather flexibly and, possibly, dynamically. Also, different slot types have different capabilities with respect to control signaling: DL slot and bi-directional slot have an opportunity for conveying the assignment for DL and UL data transmission, while by contrast UL slot and bi-directional slot have an opportunity for conveying the acknowledgement for DL data transmission.

Another issue complicating L1 control signaling is that different services and/or UEs may have different requirements and capabilities in terms of Rx/Tx processing time. They may apply also different numerologies, such as different symbol and/or slot durations.

Certain embodiments address the hybrid automatic repeat request acknowledgment (HARQ-ACK) reporting on UL, for example on PUCCH. More specifically, certain embodiments relate to codebook size definition in a scenario with dynamically varying HARQ-ACK timing. Certain embodiments relate to definition of HARQ-ACK report content and size. Hybrid automatic repeat request (hybrid ARQ or HARQ) is usually a combination of error-correcting coding and ARQ. In certain embodiments, HARQ-ACK (or non-acknowledgement, NACK) is transmitted for DL data with regard to the HARQ process at issue (data may be in the form of a transport block, codeword or like). HARQ-ACK codebook is set of HARQ-ACK bits that are are ordered in a predetermined manner and jointly coded. Multiple codebooks, corresponding to e.g. plurality of cells and determined separately for each cell may be concatenated into single joint codebook.

Dynamic HARQ-ACK timing can refer to the fact that the number of reported HARQ-ACK bits/slot may vary from slot to slot. For example, assuming that 8 different timing values are supported, the number of HARQ-ACK feedback bits/slot (per cell) may vary between 0 and 16, assuming that each DL slot creates up to two HARQ-ACK feedback bits. The variation in the number of HARQ-ACK feedback bits transmitted per slot is increased even further when HARQ-ACK feedback bits for multiple DL cells are transmitted via single UL cell.

From the point of view of control channel coverage and UL control signaling resource consumption, there may be a significant difference between different HARQ-ACK payloads. For that reason, there may be a need to consider the following mechanisms as part of NR design: support for dynamically varying HARQ-ACK codebook size; and support for time domain bundling of HARQ-ACK bits transmitted in the same slot but corresponding to different DL transport blocks transmitted via different slots.

Issues related to dynamically varying HARQ-ACK codebook (CB) and/or HARQ-ACK bundling include the following: how to facilitate dynamic HARQ-ACK CB adaptation in the NR, including determination of both codebook size as well as which HARQ-ACK feedback bits are included to a codebook; how to support CB adaptation for parallel services, such as enhanced mobile broadband (eMBB) and ultra-reliable low latency communication (URLLC), as well as for different component carriers; and how to avoid and/or minimize consequences of various error cases related to DCI failure, covering both DL and UL resource allocation grants.

There is a risk that when an evolved/enhanced Node B (eNB) schedules physical downlink shared channel (PDSCH), the UE may not detect the corresponding physical downlink control channel (PDCCH) properly. Hence, the corresponding component carrier (CC)/slot may not be considered in the HARQ-ACK codebook determination. Dynamic codebook adaptation may require that UE and eNB have a common understanding of the HARQ-ACK codebook size and HARQ-ACK bit ordering within the codebook. Otherwise there may be higher layer error, such as HARQ data for which UE did not detect DL control channel properly being treated as acknowledged. Alternatively, HARQ data which UE did not detect properly and transmitted negative acknowledgment may be treated as acknowledged due to error on HARQ-ACK bit ordering. The overall probability of such error case should be extremely low, e.g. below 10⁻⁴.

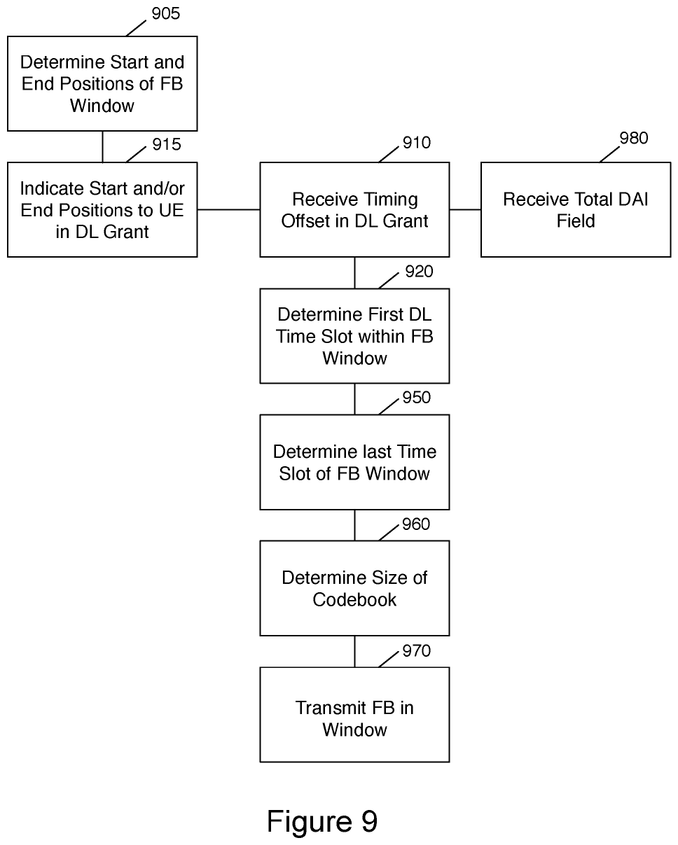

FIG. 9 illustrates a method according to certain embodiments. The method can include, at 910, receiving a timing offset value in a downlink grant. The method can also include, at 920, determining a first downlink time slot within a feedback window based on the timing offset value. Examples of the determination are presented below.

For example, a user equipment can determine that a downlink acknowledgment is associated to an uplink time slot or unit for a first time and that a new feedback window has started based on the determined association. In other words, when an access node indicates for the first time that uplink control information (UCI) shall be transmitted on a certain UL slot, the feedback window is started (the first time means, for example, the first time may relate to a certain UL time slot or unit without previous DL acknowledgement association).

The method can additionally include receiving a counter downlink assignment index field. The determining the first downlink time slot can be further based on the counter downlink assignment index field. The counter downlink assignment index is further clarified below.

The method can further include, at 950, determining a last time slot or unit of the feedback window based on information of a last downlink time slot or unit for which feedback is to be reported in an uplink time slot or unit associable with the timing offset value.

The method can also include, at 960, determining a size of a codebook for the feedback window. The size of the codebook can be determined based on the number of time slots in the feedback window. The determining the number of downlink time slot or unit, or codebook size, can be further based a downlink acknowledgment being associated to a second uplink time slot or unit occurring later for a first time. In this case, the user equipment can determine that a new, second, feedback window has started based on the determined association for the first time, and the previous downlink time slot or unit is the last downlink time slot or unit contained in the first codebook. This may be applicable, for example, to a case in which codebook size is also adapted.

The method can further include, at 970, transmitting the feedback for the feedback window in the UL time unit associable with the timing offset value and based on the determined size of the codebook. HARQ feedback transmission on certain UL slot may contain HARQ acknowledgements only for DL slots that have HARQ feedback associated to the certain UL slot for example based on the timing offset. This is illustrated, by way of example, in embodiment A, where the eNB may start to associate HARQ feedback to a later UL slot even before the end of current HARQ FB window. This may be done, for example, to balance HARQ feedback codebook size between UL slots. In this case, DTX/NACK can be reported in the current codebook for DL slots that belong to the current codebook but are associated to the next FB window and codebook by the timing offset. In an example, UCI transmission timing can be DCI timing plus an indicated timing offset, plus a minimum processing time, if not incorporated to the indicated timing offset.

The method can additionally include, at 980, receiving a total downlink assignment index field. The determining the number of downlink time slot or unit, or codebook size, can be further based on the total downlink assignment index field. Some further-detailed examples of the method are presented below.

The UE can determine the first DL time unit/slot of a HARQ-ACK FB window based on an indication of a HARQ-ACK timing offset value in a DL grant, for example in DCI. When a DL HARQ-ACK feedback is associated to a certain UL time unit, such as slot or mini-slot, for the first time, the UE can determine that a new HARQ-ACK feedback (FB) window has started.

In other words, if the UE finds an indication of a timing offset value in a DL grant, the UE can know whether or not a new HARQ-ACK window has started. The indication can be the timing indicator in DCI. Based on that indication the UE can determine a tabled value for the timing offset.

The UE can use the resources indicated by the timing offset for HARQ-ACK transmission. In one embodiment, the UE may be (pre)configured to add the UE's minimum processing time to the timing offset for determining the time slot to be used for UL transmission. In another embodiment, the minimum processing time can be taken into consideration in the mapping of timing offset values, which can be referred to as the tabled values.

The UE can determine the size of a codebook for the HARQ-ACK FB window. For example, the size of the codebook, which can refer to the number of HARQ-ACK bits, can be adapted for the HARQ-ACK FB window as follows. In an embodiment called “embodiment A” for convenience only, the size of a codebook can be defined based on how many DL time slots the access node can schedule in the window at issue. By contrast, in an embodiment called “embodiment B” for convenience only, the size of a codebook can be defined based on how many DL time slots the access node actually schedules in the window at issue. Embodiment B may require a total DAI-field. The total DAI-field can also enable time domain HARQ-ACK bundling in the FB window. Time domain bundling can correspond to a logical-AND-operation of HARQ-ACK bits within HARQ-ACK FB window, compressing the HARQ-ACK feedback into single feedback bit per a codeword. In certain embodiments, the size of a codebook can be determined cell-wise based on the number of time slots, not based on the number of carriers. Similarly, the size of a codebook can be determined cell-wise for each cell or virtual cell of a plurality of cells or virtual cells.

In embodiment A, a simple form of dynamic codebook adaptation can be based on the HARQ-ACK timing offset value included in DL grant. In this method, HARQ-ACK codebook size can be determined according to the number of HARQ-ACK timing options smaller or equal than HARQ-ACK timing offset included in the first DL grant in the HARQ-ACK FB window.

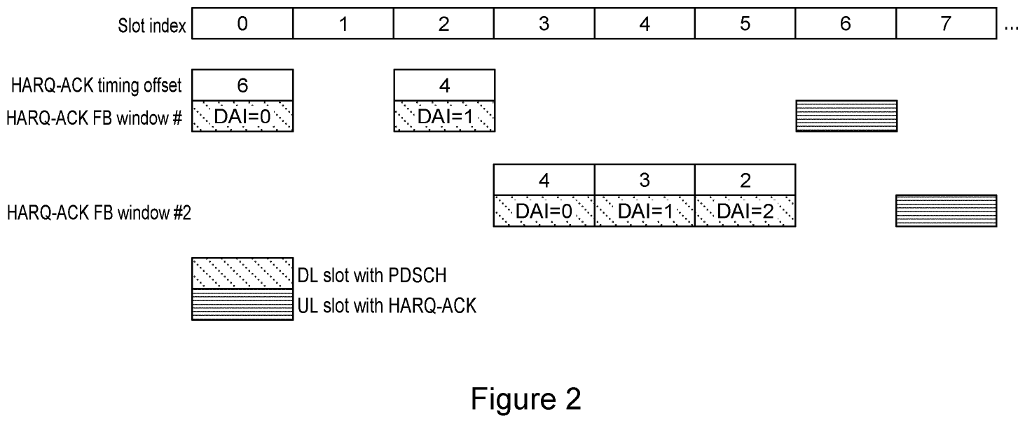

In the method according to certain embodiments, a HARQ-ACK codebook can be defined separately for each virtual HARQ-ACK cell. Each component carrier or cell can constitute a virtual HARQ-ACK cell. Additionally, it is possible to define separate virtual cell also for different service types or numerologies, such as eMBB and URLLC, running in parallel in the same DL component carrier or cell. Thus, a virtual HARQ-ACK cell may be, in addition to a normal radio cell, defined for a virtual cell as well. For example, support for a consistent user experience, higher speed, lower latency, greater spectrum efficiency and support for Internet of Things (IoT) may require using cell virtualization a single physical cell by dynamically dividing it into multiple virtual cells for determination of HARQ-ACK feedback. In this concept, UE may determine a plurality of codebooks for a same carrier, or radio cell, each codebook associated with certain numerology and/or latency configuration and transmit according to those codebooks using one or more transmission. With regard to carrier aggregation, a virtual cell can be defined for each component carrier separately. Certain embodiments cover different scenarios with one and multiple virtual HARQ-ACK cells. FIG. 2 illustrates an example scenario for determining a HARQ-ACK feedback (FB) window for one virtual HARQ-ACK cell, according to certain embodiments. As shown in FIG. 2, within each virtual HARQ-ACK cell, the following principles can be applied: HARQ-ACK corresponding to one physical downlink shared channel (PDSCH) slot or mini-slot may be part of only one HARQ-ACK FB window; HARQ-ACK within a certain HARQ-ACK FB window may be associated to only one DL time unit, such as slot or mini-slot, while HARQ-ACK of a certain HARQ-ACK FB window can be associated to and transmitted on only one UL time unit; and starting and ending positions of a certain HARQ-ACK FB window can be dynamic and determined by an access node and indicated by downlink control information (DCI).

For example, if a service provided requires short latency, the access node can configure a short HARQ-ACK FB window, or alternatively the access node may try to minimize UL control overhead by a long HARQ-ACK FB window. The dynamics of HARQ-ACK timing can define the limits for the length of the HARQ-ACK FB window. The dynamics can be standardized.

The HARQ-ACK FB window can indicate the DL time slots for which HARQ-ACKs are transmitted in one UL time slot. Each virtual cell can have a window of its own.

For users that are scheduled on a plurality of virtual HARQ-ACK cells, there may be separate HARQ processes cell-wise. However, it may be possible to use a single ACK/NACK for transmission within these cells. This can be referred to as HARQ bundling.

Counter downlink assignment index (DAI) with modulo operation (known in computer science and mathematics, and can be used for saving in the number of bits in signaling) can be included in each DL grant scheduling PDSCH slot or mini-slot and can be updated based on scheduled PDSCH within HARQ-ACK FB window by an access node. The counter DAI can be used in error detection: based on the counter DAI value, the UE can determine whether the UE received all the needed downlink grants in the HARQ_ACK FB window at issue. The counter DAI can ensure that the UE and the access node have the same view of the start time of the FB window. The processing of an error case, as discussed below, provides further illustration of this point.

If DAI=0 and HARQ-ACK is associated to certain UL time unit (slot or mini-slot) at a first time, the slot can be the first DL slot belonging to the new HARQ-ACK FB window. In the case when HARQ-ACK is associated to a certain UL slot (or mini-slot) the first time but DAI>0, the UE can determine that at least one DL grant has failed. UE will feedback negative HARQ-ACK or a value indicative of discontinuous transmission (DTX) for each failed DL grant detected based on DAI. DTX relates to an error case, where one or more PDCCH transmissions have failed. When an access node is transmitting, this error case can be seen as a discontinuous access node transmission from the UE point of view.

In certain embodiments, the DL grant can also include an indication of total DAI, which can indicate a modulo of the number of time slots scheduled or to be scheduled within the HARQ-ACK FB window. The UE can determine the last time unit/slot of the HARQ-ACK FB window based on information on the last DL time unit/slot for which a HARQ-ACK feedback can be reported or is to be reported in an UL time unit/time slot associable with the timing offset value, according to the configured/predefined minimum UE processing time between DL data reception and HARQ-ACK transmission.

The minimum UE processing time can define the smallest possible value for the dynamically changeable HARQ-ACK timing-offset. The ending position or last DL time unit/slot of the HARQ-ACK FB window can be known by the UE in advance. For example, the number of time slots schedulable in the FB window may be standardized.

The timing offset value set by an access node can indicate the UL time unit/slot associated with the DL time units/slots within the HARQ-ACK FB window for transmission of corresponding hybrid automatic repeat request-acknowledgment (HARQ-ACK) information. HARQ timing in NR may be arranged to operate with the granularity of slots.

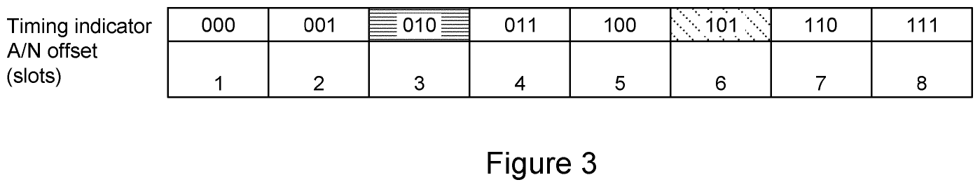

FIG. 3 illustrates a mapping of timing indicator values to A/N offset slots, according to certain embodiments. In one example, if a 3-bit signaling field is available the UE reads the value of the timing indicator from DL grant. Whether such a field is available may depend on the applied standard and/or can be determined in radio resource control configuration. The value can be, as an example only, 010 meaning DAI=0. According to the example below, 3 DL time slots can be associated with this UL time slot: slot n, A/N offset 3; slot n+1, A/N offset 2; and slot n+2, A/N offset 1. In this example, the size of the codebook is 3*2 if DL transmission mode producing 2 HARQ-ACK bits per DL slot is used, or 3*1 if spatial bundling is used or if DL transmission mode producing 1 HARQ-ACK bit per DL slot is used. By contrast, if the value were 101, the size of the codebook could be 6*2 or 6*1 in the case of spatial bundling. In other words, the size of the codebook can be defined based on the number of DL slots within the HARQ-ACK FB window, and thus based on the number of HARQ-ACKs, which can be associated with the UL slot. It should be appreciated that timing relationship (timing offset) between DL data reception and corresponding acknowledgement can be dynamically indicated by L1 signaling (e.g., DCI), semi-statically indicated to a UE via higher layer or a combination of indication by higher layers and dynamic L1 signaling (e.g., DCI). By using 2 bit signaling, 4 states may be indicated.

In embodiment B, a DL grant can include in addition to counter DAI, also total DAI, as mentioned above. Total DAI can contain the information about the number of scheduled or to be scheduled DL slots (with modulo operation) within the HARQ-ACK FB window. This approach of including both indications can facilitate the following functionalities.

For example, including both indications can facilitate determining the HARQ-ACK codebook size according to actual number of scheduled DL slots. This can facilitate further possibilities for HARQ-ACK codebook size adaptation, based on the actual DL scheduling. The eNB may be flexible in defining total DAI. For example, the eNB may define not to send the last PDCCH/PDSCH mapped to the codebook at all.

Including both indications can also facilitate support for time domain bundling of HARQ-ACK bits within HARQ-ACK FB window. This may allow minimization of the HARQ-ACK codebook size to support coverage limited situations, such as when using short PUCCH. Time domain bundling can correspond to a logical AND operation of HARQ-ACK bits within a HARQ-ACK FB window, compressing the HARQ-ACK feedback into single feedback bit per codeword.

When using Embodiment B, selection between HARQ-ACK multiplexing and HARQ-ACK bundling may be done either semi-statically or dynamically. In the latter case, the bundling may be based on explicit signaling Another option is to signal bundling implicitly, for example based on slot type. Following this approach, bundling may be selected for slot types supporting only short PUCCH whereas multiplexing can be selected if long PUCCH is available.

The UE can transmit the HARQ-ACK feedback for DL time units in the HARQ-ACK FB window in the UL time unit associable with the timing offset value and based on the determined codebook size. The transmission may take place on physical uplink control channel (PUCCH) or uplink control information (UCI) on PUSCH or on any suitable UL channel.

The UE can transmit HARQ-ACKs for the plurality of time slots/time units, as indicated by the HARQ-ACK window, in one UL time slot/time unit. The HARQ-ACKs may be coded into the one UL time slot in a preconfigured order, for example according to counter DAI. In embodiment B, bundling is also an option.

From the UE point of view, when transmitting HARQ-ACK feedback in certain UL time unit (such as slot, or mini-slot, or multiple slots), the UE may combine HARQ-ACK corresponding to one or multiple virtual HARQ-ACK cells together. The multiple HARQ-ACKs can be separately or jointly coded within a single UL channel, such as long PUCCH. Another option is to transmit them in parallel using two or more HARQ-ACK channels, such as long PUCCH and short PUCCH. In the case of joint coding, the HARQ-ACK codebooks defined separately for each virtual HARQ-ACK cell can be combined into a single HARQ-ACK codebook, with codebook size given by the sum of separate codebook sizes.

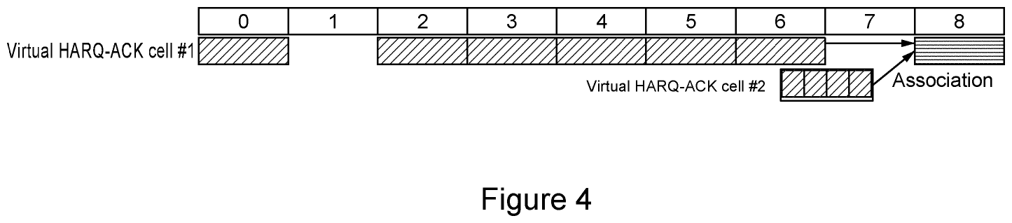

FIG. 4 illustrates a scenario with two virtual HARQ-ACK cells, according to certain embodiments. The virtual cells could be, for example, in a carrier aggregation scenario a primary cell (PCell) that is running with 15 kHz subcarrier spacing, and a secondary cell (SCell) running with 60 kHz subcarrier spacing. Virtual cells could also correspond to, for example, eMBB and URLLC service types provided on the same carrier but with different subcarrier spacings.

The mapping in FIG. 3 can also provide an example of HARQ-ACK timing indicator values that can be used in the dynamic HARQ-ACK codebook adaptation based on Embodiment A. If the HARQ-ACK timing value is indicated to UE by means of 3-bit signaling included in DL grant and the signaled HARQ-ACK timing value corresponding to the first DL slot in the HARQ FB window is “011”, then using the mapping of FIG. 3 a maximum 4 slots can be associated to current HARQ-ACK FB window. Thus, the corresponding HARQ-ACK codebook size may be 8 bits in the case with 2 HARQ-ACK bits per slot, and 4 bits otherwise, including also a case with spatial bundling.

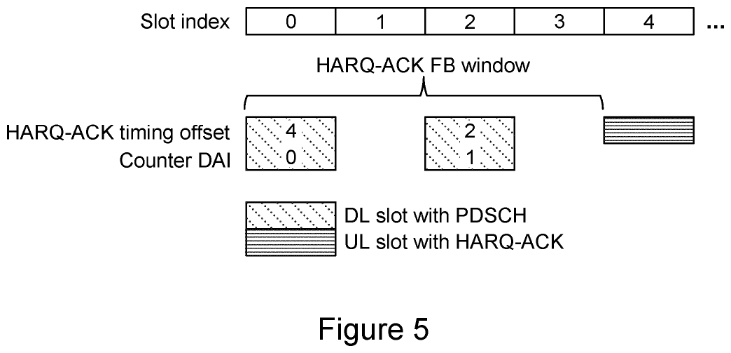

FIG. 5 illustrates an example implementation in time domain, according to certain embodiments. The actual HARQ-ACK feedback message can be created according to DAI bits, in the following manner: codebook size 4 bits; HARQ-ACK bit #1 corresponds to slot with DAI=0; HARQ-ACK bit #2 corresponds to slot with DAI=1; and NACK for remaining 2 bits in the codebook or generally speaking to all slots after the slot with DAI=1 for which DL assignment is not received by UE.

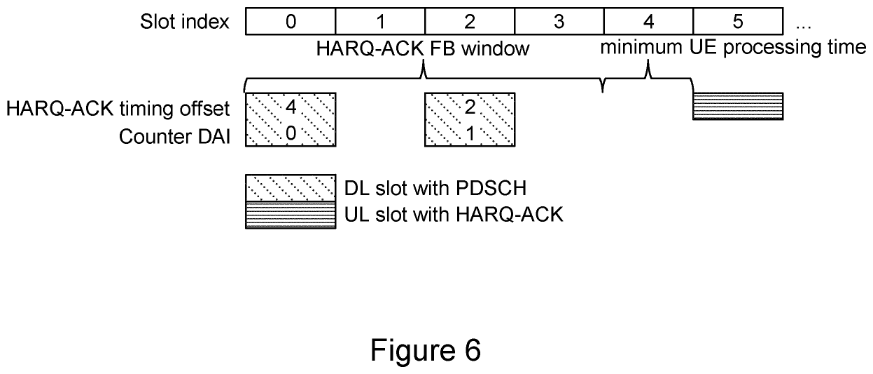

FIG. 6 illustrates another example implementation, according to certain embodiments. FIG. 6 is similar to FIG. 5 but in this example there is a 5 slot A/N offset signaled in slot#0 and minimum processing time of one slot configured to the UE.

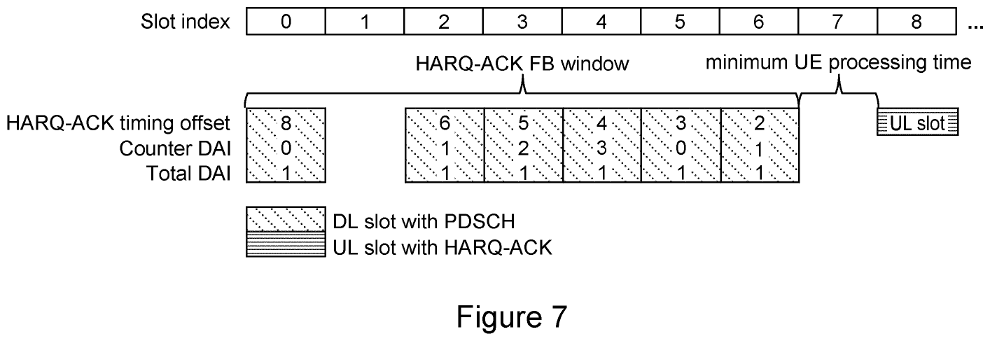

FIG. 7 illustrates an exemplary scenario, according to certain embodiments. More particularly, FIG. 7 illustrates a case of Embodiment B. In this case, codebook size determination can be based on HARQ-ACK timing indicator and total DAI. Thus, FIG. 7 provides an example of dynamic HARQ-ACK codebook adaptation based on Embodiment B. Total DAI can contain the information about the number of scheduled (or to be scheduled) DL slots within the HARQ-ACK FB window (with modulo operation).

In the example illustrated in FIG. 7, the HARQ-ACK FB window is dimensioned to be 8 slots based on the HARQ-ACK timing offset and configured/predetermined minimum UE processing time. The UE can determine that 6 slots are scheduled within the HARQ-ACK FB window based on Counter DAI and Total DAI, which means that the actual HARQ-ACK codebook size may either be 6 or 12 bits, depending on the DL transmission mode and spatial bundling.

In slot #0, when UE receives Total DAI value of 1 with HARQ-ACK timing offset of 8, the UE can determine that either 2 or 6 slots will be scheduled within the HARQ-ACK FB window. The UE can determine that the number of scheduled slots is 6 when it receives DL assignment in any of slots #2-#6. The HARQ-ACK feedback message can be arranged according to DAI similarly as in the example above.

The method according to FIG. 9 may implement one or more of the above-described embodiments, including Embodiment A and Embodiment B.

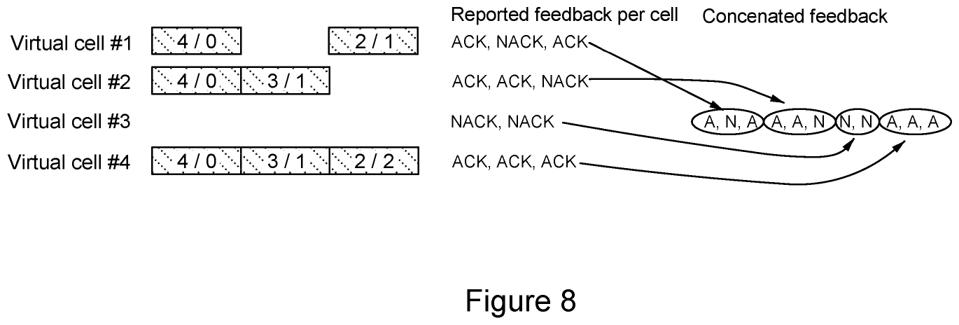

FIG. 8 illustrates an example of error case handling, according to certain embodiments. There can be an error case related to joint coding of multiple virtual HARQ-ACK cells. It is possible that all DL grants related to certain virtual HARQ-ACK cells fail. This may be the case for example when only one PDSCH is allocated in one virtual HARQ-ACK cell.

In order to avoid the error case, or for other reasons, it is possible to always reserve some minimum HARQ-ACK codebook size, for example one or two bits for each involved virtual HARQ-ACK cell. Those bits can be NACKed, in the case when a UE configured to support multiple virtual HARQ-ACK cells has received PDSCH only for one virtual HARQ-ACK cell or when UE receives PDSCH at least on one virtual HARQ-ACK cell but not on all virtual HARQ-ACK cells. This is illustrated in FIG. 8 where no PDSCH is scheduled to the UE in virtual cell #3.

Corresponding features may be provided at an access node, such as an eNB. For example, the method can include determining, at 905, starting and ending positions of a feedback window. The method can also include transmitting a downlink grant to a user equipment. The downlink grant can indicate at least one of the starting or ending positions to the user equipment.

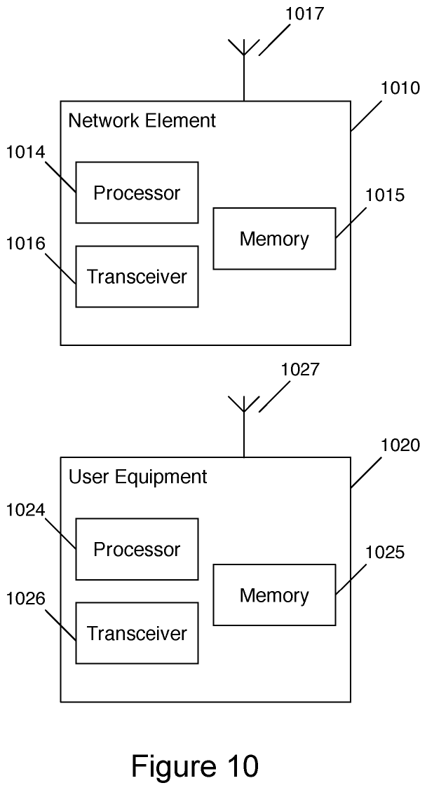

FIG. 10 illustrates a system according to certain embodiments of the invention. It should be understood that each block of the flowchart of FIG. 9 may be implemented by various means or their combinations, such as hardware, software, firmware, one or more processors and/or circuitry. In one embodiment, a system may include several devices, such as, for example, network element 1010 and user equipment (UE) or user device 1020. The system may include more than one UE 1020 and more than one network element 1010, although only one of each is shown for the purposes of illustration. A network element can be an access point, a base station, an eNode B (eNB), or any other network element, such as a PCell base station or a SCell base station.

Each of these devices may include at least one processor or control unit or module, respectively indicated as 1014 and 1024. At least one memory may be provided in each device, and indicated as 1015 and 1025, respectively. The memory may include computer program instructions or computer code contained therein, for example for carrying out the embodiments described above. One or more transceiver 1016 and 1026 may be provided, and each device may also include an antenna, respectively illustrated as 1017 and 1027. Although only one antenna each is shown, many antennas and multiple antenna elements may be provided to each of the devices. Other configurations of these devices, for example, may be provided. For example, network element 1010 and UE 1020 may be additionally configured for wired communication, in addition to wireless communication, and in such a case antennas 1017 and 1027 may illustrate any form of communication hardware, without being limited to merely an antenna.

Transceivers 1016 and 1026 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner. In other words, division of labor may vary case by case. One possible use is to make a network element to deliver local content. One or more functionalities may also be implemented as a virtual application that is provided as software that can run on a server.

A user device or user equipment 1020 may be a mobile station (MS) such as a mobile phone or smart phone or multimedia device, a computer, such as a tablet, provided with wireless communication capabilities, personal data or digital assistant (PDA) provided with wireless communication capabilities, vehicle, portable media player, digital camera, pocket video camera, navigation unit provided with wireless communication capabilities or any combinations thereof The user device or user equipment 1020 may be a sensor or smart meter, or other device that may usually be configured for a single location.

In an exemplifying embodiment, an apparatus, such as a node or user device, may include means for carrying out embodiments described above in relation to FIG. 9.

Processors 1014 and 1024 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof The processors may be implemented as a single controller, or a plurality of controllers or processors. Additionally, the processors may be implemented as a pool of processors in a local configuration, in a cloud configuration, or in a combination thereof The term circuitry may refer to one or more electric or electronic circuits. The term processor may refer to circuitry, such as logic circuitry, that responds to and processes instructions that drive a computer.

For firmware or software, the implementation may include modules or units of at least one chip set (e.g., procedures, functions, and so on). Memories 1015 and 1025 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 1010 and/or UE 1020, to perform any of the processes described above (see, for example, FIG. 9). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 10 illustrates a system including a network element 1010 and a UE 1020, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

Certain embodiments may have various benefits and/or advantages. For example, certain embodiments may provide a robust arrangement for dynamic codebook adaptation for the scenario where dynamic HARQ-ACK timing is applied with flexible configuration of subframe/slot types. Moreover, certain embodiments may provide inbuilt support for carrier aggregation with different numerologies. Furthermore, certain embodiments may provide inbuilt support also for time domain bundling with a dynamic bundling window. Moreover, certain embodiments may provide a scalable solution to cover multiplexing between different services, such as URLLC and eMBB. Also, certain embodiments can be used both for PUCCH and for UCI on PUSCH.

One having ordinary skill in the art will readily understand that the various embodiments as discussed above may be practiced with steps in a different order, and/or with hardware elements in configurations which are different than those which are disclosed. Therefore, although the present disclosure has been described based upon these preferred embodiments, it would be apparent to those of skill in the art that certain modifications, variations, and alternative constructions are possible and should be understood as also included.

### LIST OF ABBREVIATIONS

3GPP Third Generation Partnership Program

ACK Acknowledgement

CA Carrier Aggregation

CB Codebook

CC Component Carrier

CSS Common Search Space

DAI Downlink Assignment Index

DCI Downlink Control Information

DL Downlink

eMBB enhanced Mobile Broadband

eNB enhanced Node B (base station according to LTE terminology)

EPDCCH Enhanced PDCCH

ETSI European Telecommunications Standards Institute

FB Feedback

FDD Frequency Division Duplex

GP Guard Period

HARQ Hybrid Automatic Repeat ReQuest

L1 Layer 1, Physical Layer

LTE Long Term Evolution

NACK Negative Acknowledgement

NR New Radio

PCell Primary Cell

PDCCH Physical Downlink Control Channel

PUCCH Physical Uplink Control Channel

PDSCH Physical Downlink Shared Channel

RAN Radio Access Network

Rel Release

SCell Secondary Cell

SI Study Item

SR Scheduling Request

TB Transport Block

TD, TDD Time Division duplex

UCI Uplink Control Information

UL Uplink

UE User Equipment

URLLC Ultra-Reliable Low-Latency Communications

WG Working Group

WI Work Item

ARI Ack/Nack resource index

According to a first embodiment, a method can include receiving a timing offset value in a downlink grant. The method can also include determining a first downlink time slot within a feedback window based on the timing offset value.

In a variant, the method can further include determining that a downlink acknowledgment is associated to an uplink time slot for a first time. The method can additionally include determining that a new feedback window has started based on the determined association for the first time.

In a variant, the determining an uplink time slot may further be based on adding a minimum processing time to the timing offset.

In a variant, the method can further include determining a last time slot of the feedback window based on information of a last downlink time slot for which feedback can be reported in an uplink time slot associable with the timing offset value. In a variant, the method can further include determining a size of a codebook for the feedback window.

In a variant, the size of the codebook can be determined based on the number of time slots in the feedback window.

In a variant, the method can further include transmitting feedback for the feedback window.

In a variant, the method can also include receiving a counter downlink assignment index field. The determining the first downlink time slot can be further based on the counter downlink assignment index field.

In a variant, the method can also include receiving a total downlink assignment index field. The determining either the number of slots or codebook size can be further based on the total downlink assignment index field.

In a variant, the feedback may be time-domain bundled within the feedback window for compressing the feedback into a feedback bit per a codeword.

In a variant, the feedback window may be cell-wise, virtual cell-wise or carrier-wise.

In a further variant the feedback window can be with respect to a combination one or more cells, virtual cells, or carriers.

In a variant, the feedback can be HARQ-ACK feedback.

According to a second embodiment, a method can include determining starting and ending positions of a feedback window. The method can also include transmitting a downlink grant to a user equipment. The downlink grant can indicate at least one of the starting or ending positions to the user equipment.

The method according to the second embodiment can be usable with the method according to the first embodiment and can include all the above-mentioned variants associated with the first embodiment.

According to third and fourth embodiments, an apparatus can include means for performing the method according to the first and second embodiments respectively, in any of their variants.

According to fifth and sixth embodiments, an apparatus can include at least one processor and at least one memory including computer program code. The at least one memory and the computer program code can be configured to, with the at least one processor, cause the apparatus at least to perform the method according to the first and second embodiments respectively, in any of their variants.

According to seventh and eighth embodiments, a computer program product may encode instructions for performing a process including the method according to the first and second embodiments respectively, in any of their variants.

According to ninth and tenth embodiments, a non-transitory computer readable medium may encode instructions that, when executed in hardware, perform a process including the method according to the first and second embodiments respectively, in any of their variants.

According to eleventh and twelfth embodiments, a system may include at least one apparatus according to the third or fifth embodiments in communication with at least one apparatus according to the fourth or sixth embodiments, respectively in any of their variants.

1. A method, comprising:
receiving, by a user device, a timing offset value in a downlink grant;
determining a first downlink time slot within a feedback window based on the timing offset value;
determining a last time slot or unit of the feedback window based on information of a last downlink time slot or unit for which feedback is to be reported in an uplink time slot or unit associable with the timing offset value,
determining a size of a codebook for the feedback window, and
transmitting feedback for the feedback window in an uplink time unit associable with the timing offset value and based on the determined size of the codebook.

2. The method according to claim 1, further comprising:
determining that a downlink acknowledgment is associated to the uplink time unit for a first time and that a new feedback window has started based on the determined association.

3. The method according to claim 1 or 2, further comprising:
receiving a counter downlink assignment index field, wherein the determining the first downlink time slot is further based on the counter downlink assignment index field.

4. The method of claim 1, wherein the size of the codebook is determined based on at least one of the following a number of time slots in the feedback window, and a downlink acknowledgment being associated to a second uplink time unit occurring later for a first time.

5. The method of claim 4, wherein in the case the size of the codebook is determined based on a number of time slots in the feedback window, the size of the codebook is defmed based on how many downlink time slots are schedulable in the window at issue, or the size of the codebook is defmed based on how many downlink time slots is scheduled in the window at issue.

6. The method of claim 1, wherein the feedback comprises Hybrid Automatic Repeat ReQuest (HARQ) feedback, and wherein a certain uplink time unit contains HARQ acknowledgements only for downlink time units that have HARQ feedback associated to the certain uplink slot.

7. The method of claim 1, wherein the feedback window is cell-wise, virtual cell-wise, or carrier-wise.

8. The method of claim 1, further comprising:
receiving a total downlink assignment index field, wherein the determining the number of downlink time units, or codebook size, is further based on the total downlink assignment index field.

9. An apparatus, comprising:
at least one processor; and
at least one memory including computer program code, wherein the at least one memory and the computer program code are configured to, with the at least one processor, cause the apparatus at least to perform a process, the process comprising:
receiving, by a user device, a timing offset value in a downlink grant;
determining a first downlink time slot within a feedback window based on the timing offset value;
determining a last time slot or unit of the feedback window based on information of a last downlink time slot or unit for which feedback is to be reported in an uplink time slot or unit associable with the timing offset value,
determining a size of a codebook for the feedback window, and
transmitting feedback for the feedback window in an uplink time unit associable with the timing offset value and based on the determined size of the codebook.

10. The apparatus according to claim 9, further comprising causing the apparatus to:
determine that a downlink acknowledgment is associated to the uplink time unit for a first time and that a new feedback window has started based on the determined association.

11. The apparatus according to claim 9, further comprising causing the apparatus to:
receive a counter downlink assignment index field, wherein the determining the first downlink time slot is further based on the counter downlink assignment index field.

12. The apparatus of claim 9, wherein the size of the codebook is determined based on at least one of the following a number of time slots in the feedback window, and a downlink acknowledgment being associated to a second uplink time unit occurring later for a first time.

13. The apparatus of claim 12, wherein in the case the size of the codebook is determined based on a number of time slots in the feedback window, the size of the codebook is defined based on how many downlink time slots are schedulable in the window at issue, or the size of the codebook is defined based on how many downlink time slots is scheduled in the window at issue.

14. The apparatus of claim 9, wherein the feedback comprises Hybrid Automatic Repeat ReQuest (HARQ) feedback, wherein a certain uplink time unit contains HARQ acknowledgements only for downlink time units that have HARQ feedback associated to the certain uplink slot.

15. The apparatus of claim 9, wherein the feedback window is cell-wise, virtual cell-wise, or carrier-wise.

16. The apparatus of claim 9, further comprising causing the apparatus to
receive a total downlink assignment index field, wherein the determining the number of downlink time units, or codebook size, is further based on the total downlink assignment index field.

17. A computer program embodied on a non-transitory computer readable medium, said medium having stored thereon instructions that, when executed by an apparatus, cause the apparatus to perform operations comprising:
receiving, by a user device, a timing offset value in a downlink grant;
determining a first downlink time slot within a feedback window based on the timing offset value;
determining a last time slot or unit of the feedback window based on information of a last downlink time slot or unit for which feedback is to be reported in an uplink time slot or unit associable with the timing offset value,
determining a size of a codebook for the feedback window, and
transmitting feedback for the feedback window in an uplink time unit associable with the timing offset value and based on the determined size of the codebook.

18. (canceled)

19. (canceled)
